(19) United States
(12) Patent Application Publication
(10) Pub. No.: US 2010/0097330 A1
(43) Pub. Date: Apr. 22, 2010

(54) Methods and apparatus for improving optical performance for touch screens and related devices

(76) Inventors: James Y. Lee, Irvine, CA (US); Yimin Ji, Irvine, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/288,100

(22) Filed: Oct. 16, 2008

(51) Int. Cl. G06F 3/041; B32B 37/00

(52) U.S. Cl. 345/173; 156/285

(57) ABSTRACT

One disclosed feature of the embodiments is a method and apparatus to provide a touch screen. First and second layers having inner surfaces coated with indium tin oxide (ITO) are formed. The coated surfaces have a first refractive index. A cavity is formed by the first and second layers and a sealant that seals perimeter of the first and second layers. A fluid is filled in the cavity. The fluid has a second refractive index.

### TECHNICAL FIELD

The presently disclosed embodiments are directed to the field of optics, and more specifically to touch screen.

### BACKGROUND

There are many touch screen technologies available in the market today. Truly sunlight readable touch screens are not many. They are IR (infrared) touch screens and SAW (surface acoustic wave) touch screens. On the other hand, resistive touch screen is most popular for indoor applications because of low-cost and high resolution and can use a pointed stylus for drawing fine lines.

In general, a resistive touch screen consists of two layers and each of the two layers is coated with conductive transparent resistive ITO (indium tin oxide). The two layers are separated by a ridged spacer layer. When the top layer is deformed by finger or stylus to cause the two layers to come into electrical contact, a voltage applied across the conductive layer results in a flow of current proportional to the location of the contact. The ridged spacer sandwiched by the two layers is air, whose index of refraction mismatches to the index of refraction of the ITO coating of the two layers, creating two reflective interfaces. In direct sunlight, excessive reflection of these two interfaces of a touch screen makes the display screen un-readable.

FIG. 1 illustrates one embodiment of a common resistive touch screen consisting of film-on-glass substrate. The top layer is a flexible PET 1, and the bottom layer 2, is a glass substrate. Each of the two layers is coated with conductive transparent resistive ITO (indium tin oxide) 3, 4. The two layers are separated by a ridged spacer layer 5. In this configuration, the ITO 3, 4 layer design has an index of refraction of 2.0. The ridged spacer 5 is sandwiched between the two layers in air with an index of refraction of 1.0. Two reflective interfaces marked as 6, 7 are formed. These two interfaces create reflection.

FIGS. 2A and 2B illustrate the front and cross-sectional views, respectively, of the resistive touch screen of FIG. 1. The figures show the top layer 1, and ITO coating 3, bottom layer substrate 2, and ITO coating 4. An adhesive tape 13 is positioned around the peripherals of the touch screen. The adhesive tape 13 holds the two layers 1 and 2 together.

### SUMMARY

One disclosed feature of the embodiments is a method and apparatus to provide a touch screen. First and second layers having inner surfaces coated with indium tin oxide (ITO) are formed. The coated surfaces have a first refractive index. A cavity is formed by the first and second layers and a sealant that seals perimeter of the first and second layers. A fluid is filled in the cavity. The fluid has a second refractive index.

One disclosed feature of the embodiments is a method to fill cavity in a touch screen with fluid. A touch screen having a cavity is placed inside a chamber initially filled with vacuum. The chamber is evacuated to low pressure. A fluid is brought in contact with an opening. The chamber is returned to atmospheric pressure to fill the cavity through the opening. The opening is sealed.

One disclosed feature of the embodiments is a method to fill fluid in a touch screen. A first substrate is coated with a first coating layer having a first refractive index. A well is formed on the first coated substrate with an adhesive. The first coated substrate is placed in a vacuum chamber. A predetermined amount of fluid having a second refractive index is released from a fluid dispenser into the well. A second substrate coated with a second coating layer having the first refractive index is laminated onto the first coated substrate.

### BRIEF DESCRIPTION OF THE DRAWINGS

Embodiments may best be understood by referring to the following description and accompanying drawings that are used to illustrate embodiments. In the drawings:

FIG. 1 shows prior art of a conventional film-on-glass resistive touch screen structure.

FIG. 2A shows a front and cross-sectional view a typical conventional film-on-glass resistive touch screen of FIG. 1.

FIG. 2B shows a cross-sectional view of the prior art touch screen of FIG. 1.

FIG. 3A shows a top view of an improved film-on-glass resistive touch screen structure according to one embodiment.

FIG. 3B shows a cross-sectional view of the improved touchscreen structure of FIG. 3A according to one embodiment.

FIG. 4A shows a front of the improved touch screen with a sealant according to one embodiment.

FIG. 4B shows a cross-sectional view of the improved touch screen with sealant according to one embodiment.

FIG. 5A shows a top view of an improved touch screen to fill fluid into the cavity according to one embodiment.

FIG. 5B shows a cross-sectional view of an improved touch screen to fill fluid into the cavity according to one embodiment.

FIG. 6 shows a method of fluid filling of the cavity by way of external fluid reservoir according to one embodiment.

FIG. 7A shows another method fluid filling of the cavity via releasing predetermined amount of fluid into a well formed on a first coated substrate according to one embodiment.

FIG. 7B shows the second coated substrate is laminated onto the first coated substrate to form the touch screen according to one embodiment.

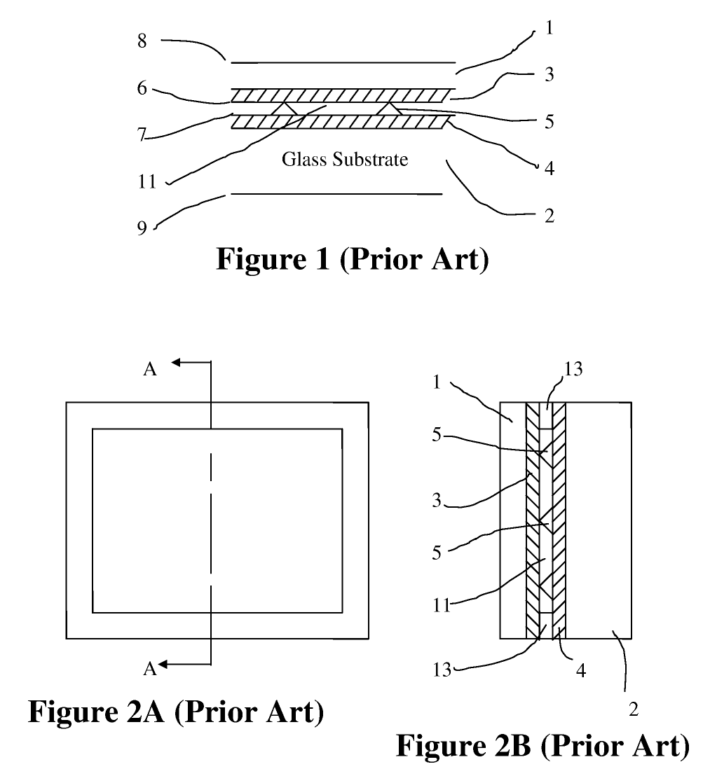

### DETAILED DESCRIPTION

While this invention is susceptible to embodiment in many different forms, a specific embodiment is shown in the drawings and described in detail. This is with the understanding that the present disclosure is to be considered as an exemplification of the principles of the invention and is not intended to limit the invention to the embodiment illustrated.

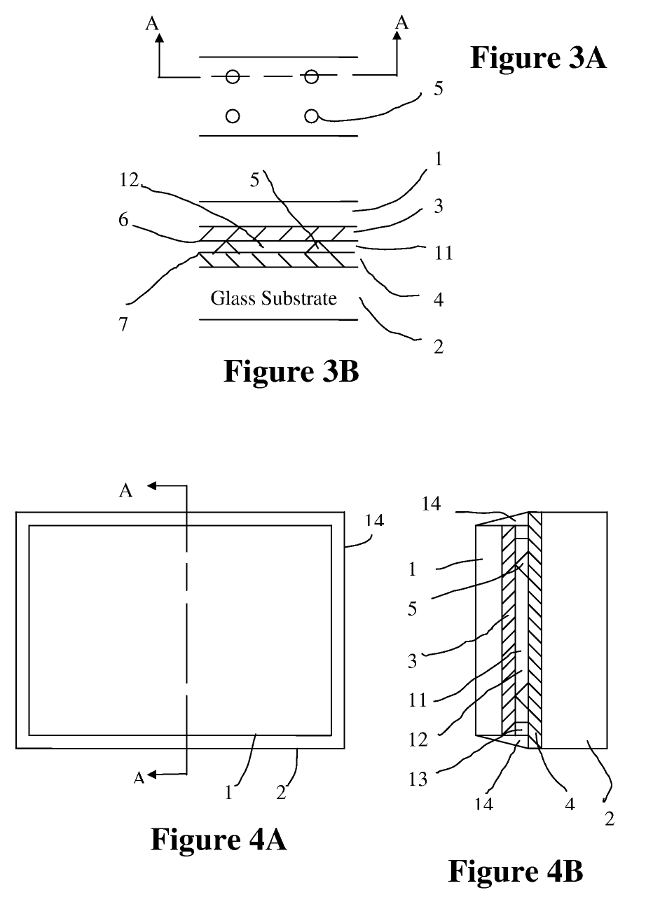

FIGS. 3A and 3B show the top view and cross-sectional views, respectively of the improved film-on-glass resistive touch screen structure according to one embodiment. The bottom, or first, layer 2 is a first substrate having an inner surface coated with a first coating layer 4 having a first refractive index. The top, or second, layer 1 is a second substrate having an inner surface coated with a second coating layer 3 having the first refractive index. In one embodiment, the first and second coating layers are made of ITO films and the first refractive index is approximately 2.0. The cavity 11 is formed by the adhesive tape 13, which serves a continuous wall, and the top and bottom layers 1 and 2. The cavity 11 is filled with fluid 12 together with the ridged spacers or dot spacers 5.

FIGS. 4A and 4B show the top and cross-sectional views of the improved touch screen with a sealant according to one embodiment. The top layer, or the second substrate, 1 is designed with a surface area smaller than the surface area of the bottom layer, or the first substrate, 2, so that a continuous border around the peripheral is formed. This allows depositing an encapsulant or a sealant 14 such as epoxy to reinforce the seal 13 of the cavity 11 which includes dot spacers 5, and fluid 12. The sealant 14 seals the perimeter of the first and second layers, or substrates, 2 and 1. The basic design of the resistive touch screen is to provide the second substrate 1 having a surface smaller than the surface area of the first substrate 2 and to provide a continuous border to seal the cavity; means to fill the cavity with fluid, and the use of a low wet-ability fluid to ITO type that provides low contact resistance between the two ITO films 3, 4 when the two ITO films 3, 4 making contact with one another. The fluid has a second refractive index ranging from 1.30 to 1.60, not near to the ITO films 3, 4 index refraction of 2.00. This provides smoother refractive index transition between the fluid 12 and the two ITO films 3, 4.

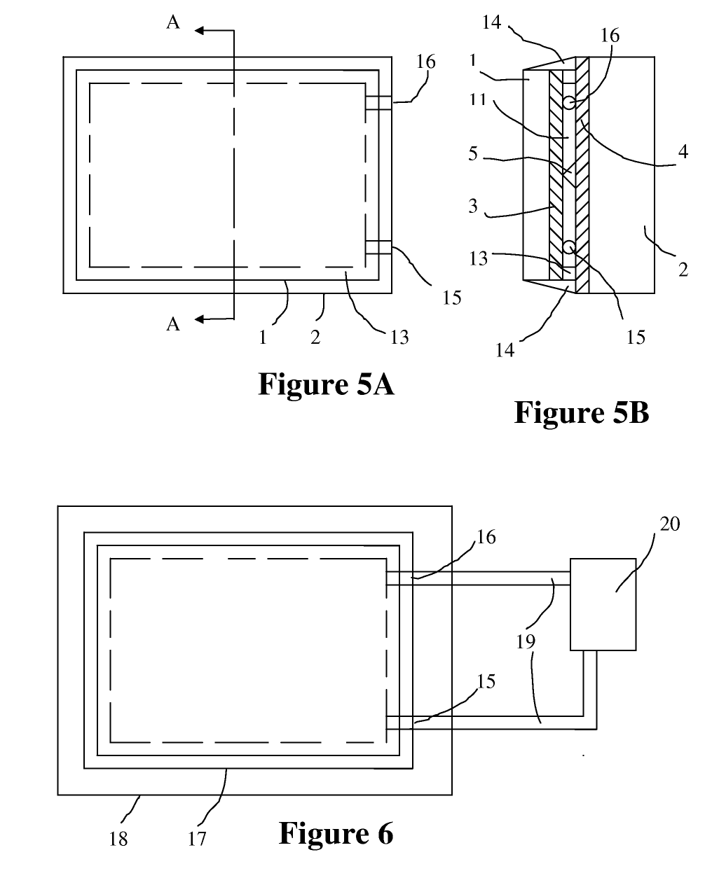

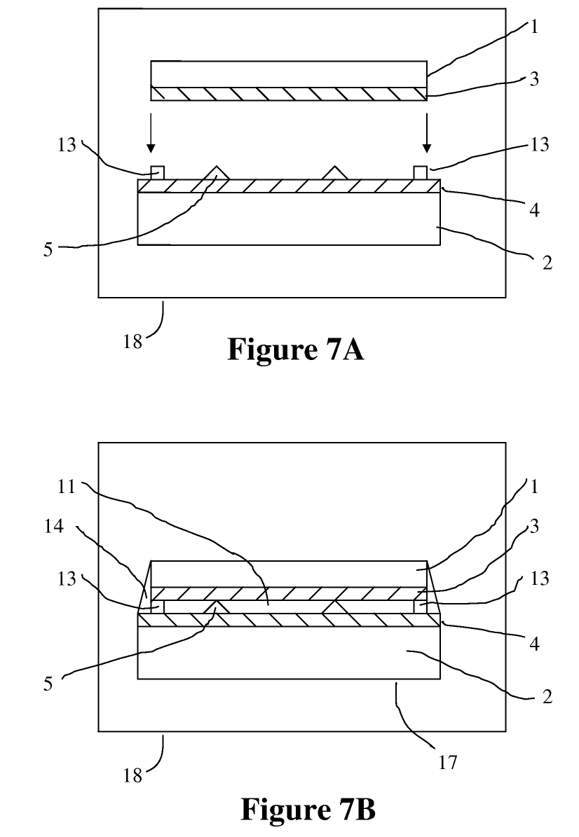

FIGS. 5A, 5B, 6, 7A and 7B show three methods of filling fluid to the cavity according to one embodiment. FIGS. 5A and 5B show fluid filling in atmospheric pressure and FIGS. 6 and 7 show fluid filling in vacuum process.

FIGS. 5A and 5B show the top and cross-sectional views of the touch screen apparatus and means to fill the fluid into the cavity 11 in atmospheric pressure.

The touch screen is first sealed with a sealant such as epoxy, preferably with silicone based material, around the perimeter 14. After it is cured and sealed, two holes 15, 16 are opened. The hole 15 is the fluid input and the hole 16 is the air output. The cavity 11 is filled with fluid using a syringe with a small needle through the hole 15. After the cavity is filled with fluid, the two holes 15 and 16 are sealed by epoxy.

The second and third methods of fluid filling are by vacuum process. FIG. 6 shows the second method, which fills the fluid into the cavity. Refer to FIGS. 5 and 6. In FIG. 5, the touch screen 17 is first sealed with a sealant such as epoxy, preferably with silicone based material, around the perimeter 14. After it is cured and sealed, two holes 15 and 16 are opened. FIG. 6 shows the touch screen 17 placed in a vacuum chamber 18 and the fluid is brought in contact with the two holes 15, 16 through two tubes 19 from an external fluid reservoir 20. The vacuum chamber 20 is then returned to the atmospheric pressure. After the chamber is returned to atmospheric pressure, the cavity 11 is fully filled with fluid. The two holes 15 and 16 are then sealed by epoxy.

FIGS. 7A and 7B show the third method of fluid filling. It is by vacuum process. In FIG. 7A, the first coated substrate 2 is installed with spacer 5 and adhesive tape 13 around the border to create a continuous wall. The wall 13 and first coated substrate 2 form a well to be filled with fluid. While the first coated substrate 2 is laid horizontally at vacuum chamber 18, a predetermined amount of fluid from the fluid dispenser is released into the well of the first coated substrate 2. The second coated substrate 1 is then laminated onto the first coated substrate 2. The result is shown in FIG. 7B, where the fluid is filled in cavity 11. Epoxy is deposited on the border 14 to reinforce the seal 13 of the cavity.

What is claimed is:

1. An apparatus comprising:
first and second layers having inner surfaces coated with indium tin oxide (ITO) having a first refractive index;
a cavity formed by the first and second layers and a sealant that seals perimeter of the first and second layers; and
a fluid filled in the cavity, the fluid having a second refractive index.

2. The apparatus of claim 1 further comprising:
a ridged spacer layer sandwiched between the first and second layers.

3. The apparatus of claim 1 wherein
the first refractive index is approximately 2.0 and the second refractive index is approximately from 1.30 to 1.60.

4. The apparatus of claim 2 wherein
the fluid has a low wet-ability.

5. A method comprising:
placing a touch screen having a cavity inside a chamber initially filled with vacuum;
evacuating the chamber to low pressure;
bringing a fluid in contact with an opening;
returning the chamber to atmospheric pressure to fill the cavity through the opening; and
sealing the opening.

6. A method comprising:
coating a first substrate with a first coating layer having a first refractive index;
forming a well on the first coated substrate with an adhesive;
placing the first coated substrate in a vacuum chamber;
releasing a predetermined amount of fluid having a second refractive index from a fluid dispenser into the well; and
laminating a second substrate coated with a second coating layer having the first refractive index onto the first coated substrate.

7. The method of claim 5 wherein
the touch screen has first and second coating layers coated on first and second substrates, respectively, the first and second coating layers having a first refractive index and the fluid has a second refractive index.

8. The method of claim 7 wherein
the first and second substrates are made of plastic.

9. The method of claim 7 wherein
the second substrate is made of plastic and the first substrate is made of glass.

10. The method of claim 7 wherein
the first substrate is larger than the second substrate to form a continuous border, suitable for depositing epoxy for sealing;

11. The method of claim 7 wherein
the first refractive index is approximately 2.0 and the second refractive index is approximately from 1.3 to 1.6.
